(19) United States
(12) Patent Application Publication
(10) Pub. No.: US 2025/0256417 A1
(43) Pub. Date: Aug. 14, 2025

(54) KNIFE SHEATH

(71) Applicant: AOB Products Company, Columbia, MO (US)

(72) Inventors: Ryan Varnum, Columbia, MO (US); Timothy S. Kinney, Warrenton, MO (US); Zach Smith, Columbia, MO (US); Matthew Kinamore, Columbia, MO (US); James Tayon, Moberly, MO (US)

(73) Assignee: AOB Products Company, Columbia, MO (US)

(21) Appl. No.: 19/052,770

(22) Filed: Feb. 13, 2025

Related U.S. Application Data
(60) Provisional application No. 63/553,465, filed on Feb. 14, 2024.

(51) Int. Cl. B26B 29/02; A45F 5/02

(52) U.S. Cl. CPC B26B 29/025; A45F 5/021

(57) ABSTRACT

A knife sheath for a knife, components thereof and associated methods. The knife has a blade and a handle. The knife sheath includes a backing comprising a first material. A shell comprises a second material different than the first material. The shell is supported by the backing. The shell and the backing bound a blade compartment sized and shaped to receive the blade of the knife. The shell has a perimeter and includes a peripheral edge margin forming a portion of the perimeter of the shell. A cover comprises a third material different than the second material. The cover is supported by the backing. The cover overlies the peripheral edge margin of the shell. The peripheral edge margin of the shell is disposed between the backing and the cover.

### CROSS-REFERENCE TO RELATED APPLICATION

The present application claims priority to U.S. Provisional App. No. 63/553,465, filed Feb. 14, 2024, the entirety of which is hereby incorporated by reference.

### FIELD

This disclosure pertains to a knife sheath and, more particularly, to a knife sheath formed from different materials.

### BACKGROUND

Knife sheaths hold and protect knives from being damaged or from causing unintended harm to someone carrying a knife.

### SUMMARY

In one aspect, a knife sheath for a knife having a blade and a handle comprises a backing comprising a first material. A shell comprises a second material different than the first material. The shell is supported by the backing. The shell and the backing bound a blade compartment sized and shaped to receive the blade of the knife. The shell has a perimeter and includes a peripheral edge margin forming a portion of the perimeter of the shell. A cover comprises a third material different than the second material. The cover is supported by the backing. The cover overlies the peripheral edge margin of the shell. The peripheral edge margin of the shell is disposed between the backing and the cover.

In another aspect, a method of manufacturing a knife sheath for a knife having a blade and a handle. The method comprises arranging a shell and a backing relative to one another so that the shell and the backing bound a blade compartment sized and shaped for receiving the blade of the knife. The backing comprises a first material and the shell comprises a second material different than the first material. The method includes arranging the shell and a cover relative to one another so that the cover overlies a peripheral edge margin of the shell. The cover comprises a third material different than the second material. The method includes securing the cover, the backing, and the shell together such that the peripheral edge margin of the shell is sandwiched between the cover and the backing.

Other objects and features of the present disclosure will be in part apparent and in part pointed out hereinafter.

### BRIEF DESCRIPTION OF THE DRAWINGS

FIG. 1 is a front view of a knife sheath according to one embodiment of the present disclosure;

FIG. 2 is a rear view of the knife sheath;

FIG. 3A is a right side view of the knife sheath;

FIG. 3B is a left side view of the knife sheath;

FIG. 4 is a perspective view of the knife sheath;

FIG. 5 is an exploded view of the knife sheath;

FIG. 6 is another perspective view of the knife sheath; and

FIG. 7 is a flow diagram depicting a method of manufacturing a knife sheath according to one embodiment of the present disclosure.

Corresponding reference numbers indicate corresponding parts throughout the drawings.

### DETAILED DESCRIPTION

The present application is directed to a knife sheath (broadly, sheath) configured to stow a knife. For example, the knife sheath can be connected to an article of clothing (such as a belt) or located between an article of clothing and a body part (e.g., waist). The knife sheath has a hybrid construction including materials of different types to offer benefits of each. The sheath can stow other types of tools besides a knife, such as pliers, scissors, etc., without departing from the scope of the present disclosure.

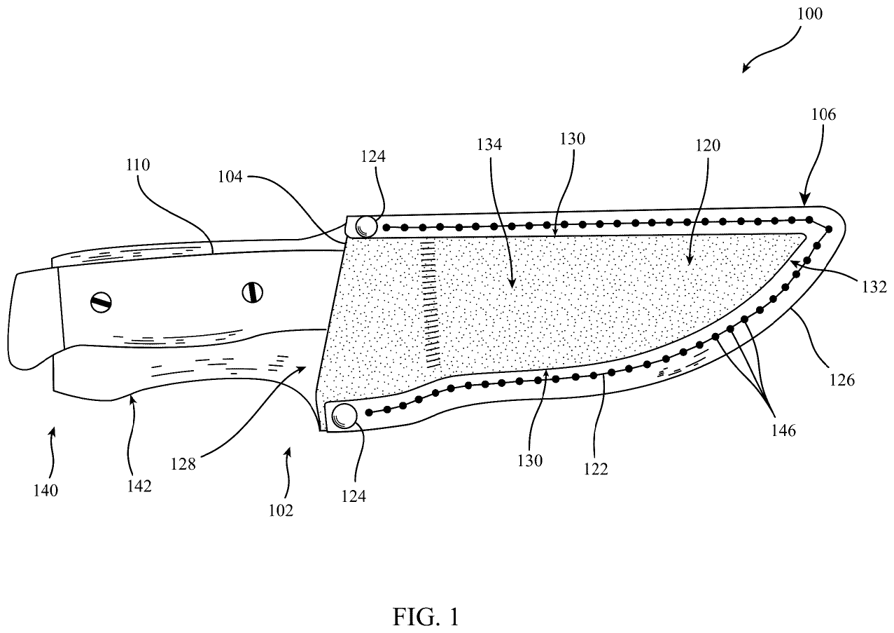

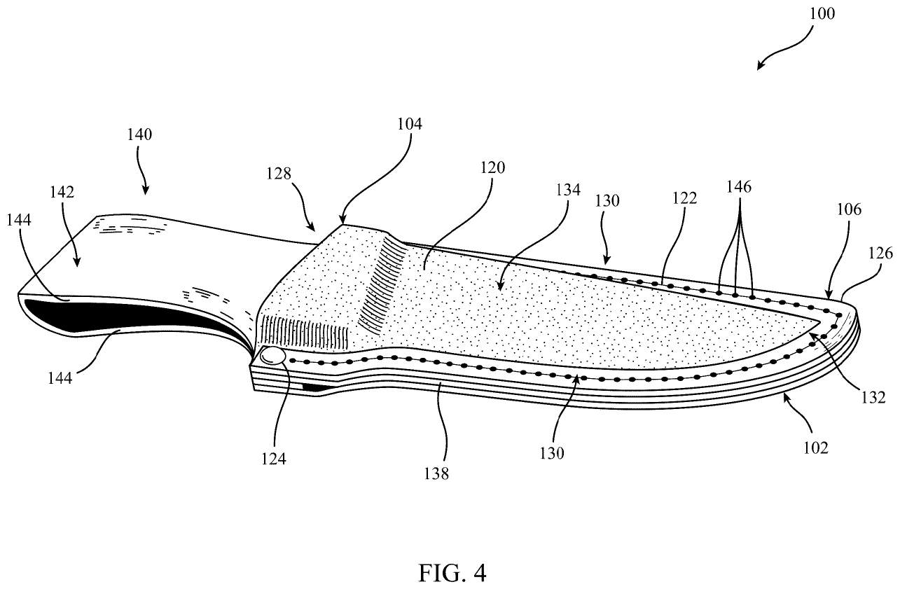

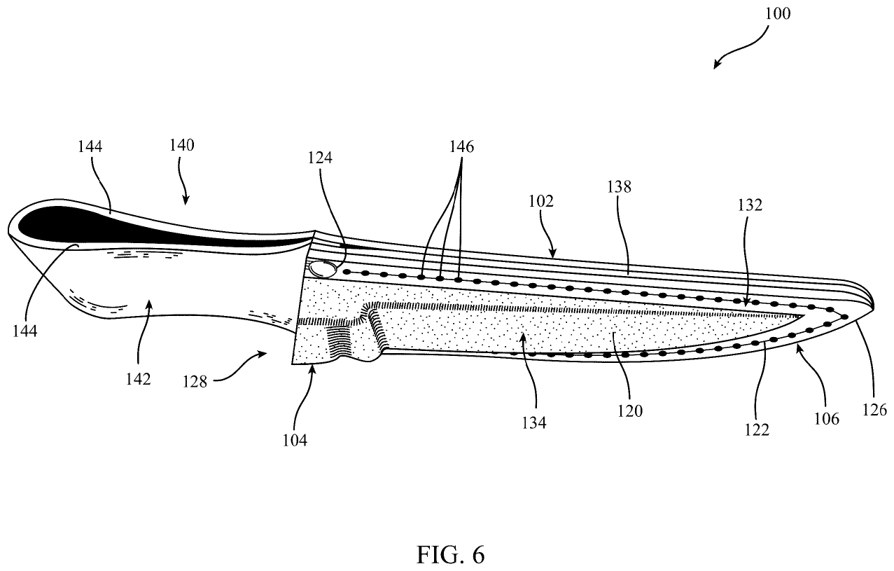

Referring to FIGS. 1-6, a knife sheath in accordance with one embodiment of the present disclosure is generally indicated at reference number 100. The knife sheath 100 has a sheath body comprising a backing 102, a shell 104, and a cover 106. The backing 102 comprises (e.g., is made of) a first material, the shell 104 comprises a second material different than the first material, and the cover 106 comprises a third material different than the second material. The third material may be the same or different than the first material. The shell 104 is supported on the backing 102. Together, the backing 102 and the shell 104 define or bound a blade compartment 108 sized and shaped for receiving the blade of a knife 110. The cover 106 is also supported by the backing 102, and overlies a peripheral edge margin 112 of the shell 104. The materials of the backing 102, the shell 104, and the cover 106, in addition to their arrangement and assembly, provide both flexibility and durability. It will be appreciated that other configurations can be used without departing from the scope of the present disclosure.

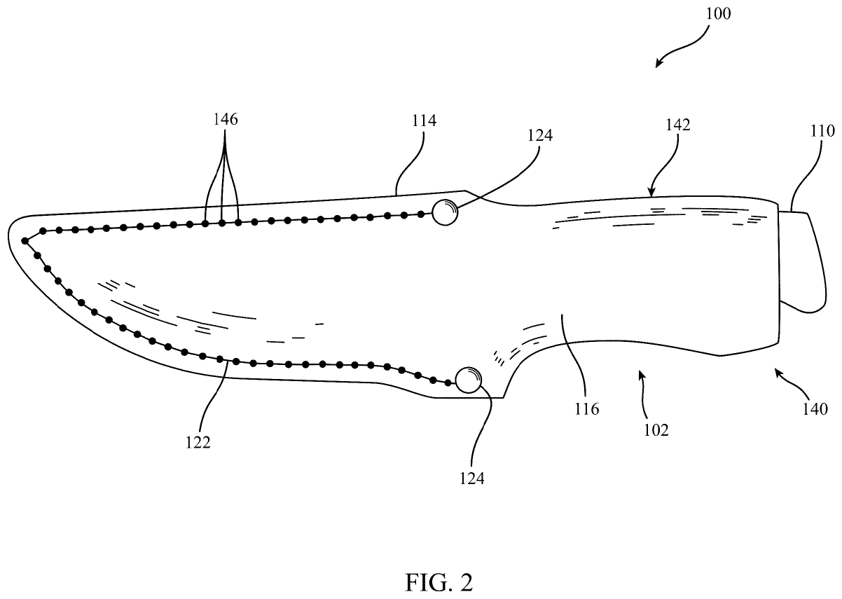

The knife sheath 100 (e.g., sheath body) has an outer or front (first) face 120 and an opposite rear (second) face 116. The outer face 120 (FIG. 1) is arranged to be distal to or face away from a user's body when the knife sheath 100 is worn by a user. The rear face 116 (FIG. 2) is arranged to be proximal to or face a user's body when the knife sheath is worn by a user. The backing 102 primarily (e.g., entirely) forms the rear face 116. The shell 104 and cover 106 primarily (e.g., entirely) form the front face 120.

The backing 102 and shell 104 are, desirably, formed of different materials to provide different advantages. The backing 102 is desirably made of a first material having a first flexibility, the material being flexibly conformable to provide comfort and protection on the rear face 116 that faces the user. For example, the first material can comprise leather, flexible PVC, and/or any other suitable material, such as a fabric. The shell 104 is desirably made of a second material having a second flexibility. The second material is less flexibly conformable than the backing 102 (e.g., more rigid than the backing, more rigid than the first material). In one embodiment, the second material is molded (e.g., heat formed or injection molded, etc.) to provide a generally conforming fit to the knife 110 to receive and releasably retain the knife in the blade compartment 108 such as by a friction or interference fit. Thus, the first flexibility is greater than the second flexibility. For example, the second material can comprise a relatively rigid (more rigid than the backing 102) polymeric or plastic material such as Kydex (thermoplastic acrylic-polyvinyl chloride). This allows the shell 104 to provide impact resistance to breakage, scratch and cut resistance, and good strength and stiffness to hold its shape over time (relative to the backing 102). Other shell materials can be used, such as other thermoplastic materials, other polymeric materials, and/or injection molded polymers, etc., without departing from the scope of the present disclosure. Example materials include nylon, PVC, and/or polyethylene, etc. The backing 102 and shell 104 provide a synergy of the backing being softer and more comfortable to a user's body, and the shell being more robust and better holding its shape over time for durably maintaining a releasable interference fit with the knife 110 for retaining the knife in the sheath 100. The outer face or surface of the shell 104 can include indicia (e.g., brand indicia), such as a molded or laser etched logo.

The shell 104 and the backing 102 are coupled together to form a knife receiver defining the blade compartment 108. The shell 104 can be coupled to the backing 102 in various ways. In the illustrated embodiment, the shell 104 is coupled to the backing 102 by stitching 122 (e.g., thread, cord, etc.) and two (broadly, one or more) rivets 124. The stitching and rivets can be referred to broadly as fasteners. Other ways of coupling the shell and the backing can be used without departing from the scope of the present disclosure. For example, the shell can be coupled to the backing with stitching, without rivets. In another embodiment, the shell is coupled to the backing with rivets, without stitching. Further, in another embodiment, a bonding agent such as an adhesive can be used. Stitching, rivet(s), adhesive, or a combination of all or some thereof can be used to couple the shell and the backing.

The shell 104 and the backing 102 each have interior surfaces (e.g., an outer face or surface of the backing and an inner face or surface of the shell) that face one another to bound the blade compartment 108. The interior surface of the backing 102 generally faces outward and bounds the proximal side of the blade compartment 108. The interior surface of the shell 102 generally faces toward the user (when the knife sheath 100 is worn by the user) and bounds the distal side of the blade compartment 108. Desirably, the blade compartment 108 is sized and shaped to receive the entire cutting edge of the blade of the knife 110. In the illustrated embodiment, the blade compartment is sized and shaped to receive the entire blade of the knife 110. The blade compartment 108 can also be sized and shaped to receive at least a portion of the handle of the knife 110. In the illustrated embodiment, the blade compartment 108 is sized and shaped to receive the end portion of the handle adjacent the blade. The blade compartment 108 includes a compartment opening (e.g., top or upper opening) sized and shaped to permit the knife 110 (e.g., blade, handle) to be inserted into and removed from blade compartment. The shell 102 includes a handle-receiving portion adjacent the compartment opening for receiving and frictionally engaging the handle of the knife. The handle-receiving portion of the shell protrudes relative to a blade-receiving portion of the shell to conform to the shape and profile of the knife.

In the illustrated embodiment, the cover 106 is configured to cover the peripheral edge margin 112 of the shell 104 and is maintained on the front face of the shell 120. The backing 102 has a perimeter 114 and the shell 104 has a perimeter 118. The shell perimeter 118 is partly formed by the peripheral edge margin 112 which extends outwardly from the main or central body of the shell 104. The main body of the shell 104 generally overlies the blade of the knife 110, when the blade is received in the blade compartment 108. In the illustrated embodiment, the peripheral edge margin 112 is formed by a flange extending out (laterally out) from the main body of the shell 104. The cover 106 overlies the portion of the shell perimeter 118 which is formed by the peripheral edge margin 112. Opposite ends of the peripheral edge margin 112 of the shell 104 are disposed on opposite sides (e.g., left and right sides) of the opening of the blade compartment 108. The peripheral edge margin 112 comprises segments or sections which extend along the edges (e.g., cutting edge, spine) of the blade of the knife 110.

The cover 106 (e.g., segment or sections thereof) extend along the peripheral edge margin 112 of the shell 104. Desirably, the cover 106 extends along nearly the entirety (90% or more) of the peripheral edge margin 112 of the shell 104 not at the mouth of the blade cavity. The cover 106 extends from an upper end 128 of the shell 104, down one side of the shell 130, around the bottom of the shell 132, and back up the other side of the shell. The illustrated cover is formed by a single piece (e.g., strip) of material. Other configurations can be used without departing from the scope of the present disclosure. For example, the cover can be segmented, including different segments around the edge margin of the shell. Desirably, the cover 106 leaves a central portion of the shell 134 exposed so that the shell 104 defines a substantial portion of a visible portion of the sheath 100 at the outer face of the sheath. The cover 106 is coupled to the shell 104 and/or backing 102 to maintain the location of the cover with respect to the shell. The shell 104 is sandwiched by the cover 106 and the backing 102 at the peripheral edge margin 112. The inner face or surface of the cover 106 lies against (e.g., is in face-to-face engagement) with the outer face or surface of the shell 104, and the outer face or surface of the backing 102 lies against (e.g., is in face-to-face engagement) with the inner face or surface of the shell. In the illustrated embodiment, the backing 102, the shell 104 (e.g., the peripheral edge margin 112 thereof), and the cover 106 are coupled by the stitching 122 and rivets 124 passing therethrough. Other ways of coupling the cover to the shell and/or backing can be used without departing from the scope of the present disclosure. For example, the cover can be coupled to the shell and/or backing with stitching, rivet(s), adhesive, or a combination of all or some thereof.

The cover 106 is, desirably, formed of a material that is softer and/or more flexibly conformable than the material of the shell 104. For example, the cover 106 can comprise the same first material as the backing 102 (i.e., the third material can be the same as the first material). In one embodiment, the first and third materials of the backing 102 and the cover 106 each comprise leather. It will be appreciated that the cover 106 can comprise a different material (e.g., different than the first and second materials), such as flexible PVC or a fabric, etc., without departing from the scope of the present disclosure.

The cover 106 provides various advantages. For example, the cover 106 inhibits contact with the edge of the shell 138, which could otherwise present a risk for scratching or irritating a user (because of its harder or more rigid second material). In the illustrated embodiment, the edge 138 of the shell 104 formed by the peripheral edge margin 112 is exposed and visible, but the cover 106 overlies the edge reducing the risk of scratching or irritation to the user. Specifically, the cover 106 overlies the edge 138 and the backing underlies the edge to inhibit contact. The cover and backing sandwich the edge margin of the shell. In the illustrated embodiment, the cover 106 comprises a perimeter 126 (e.g., edge) which is in registration (e.g., aligned) with the backing perimeter 114 (e.g., edge) and the portion (e.g., edge 138) of the shell perimeter 118 formed by the peripheral edge margin 112 of the shell 104. In other embodiments, the edge 138 of the shell 104 is recessed relative to the perimeter 126 of the cover 106 and/or the perimeter 114 of the backing 102. Desirably, the edge 138 of the shell 104 is not proud of (does not extend beyond) the cover 106 and/or backing 102 (e.g., the perimeters thereof). Desirably, the shell 104 has a footprint approximating or slightly smaller than the footprint of the backing 102. The cover 106 provides a more comfortable feel around the peripheral edge margin of the shell 112 and around the blade compartment 108. Moreover, the cover 106 provides pleasing aesthetics in a hybrid knife sheath 100 by better integrating the different materials.

In the illustrated embodiment, the cover 106 is a component separate and distinct from the backing 102, which are joined together. In one embodiment, the cover is an integral part of the backing (e.g., the cover and backing are an integrally formed one-piece component). For example, the cover can be formed as an integral piece of material with the backing and folded over the peripheral edge margin 112 of the shell 104 to form the cover. In this embodiment, an edge 138 of the shell 104 formed by the peripheral edge margin 112 is covered to prevent a user or other person from inadvertently being scratched or otherwise irritated by the edge.

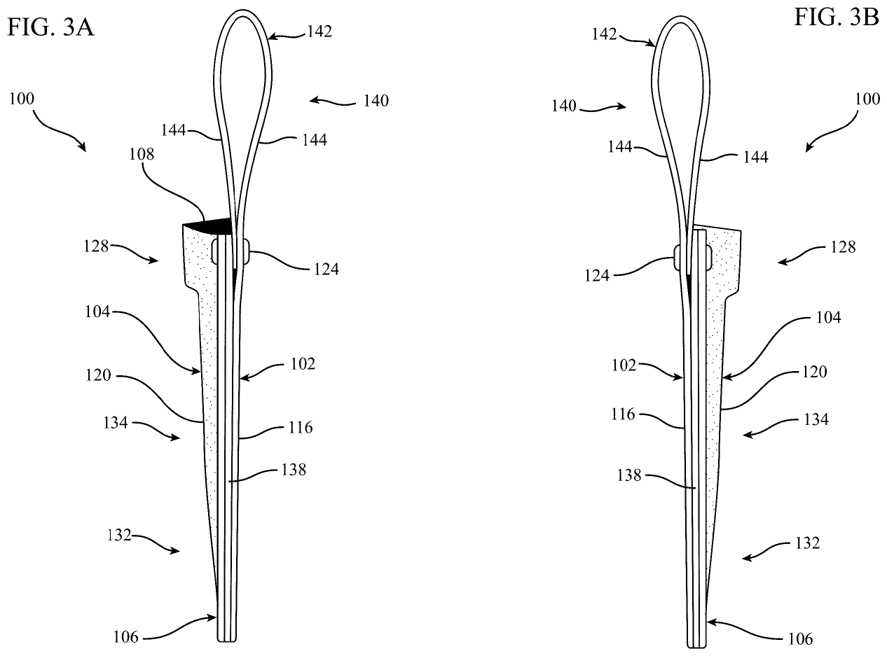

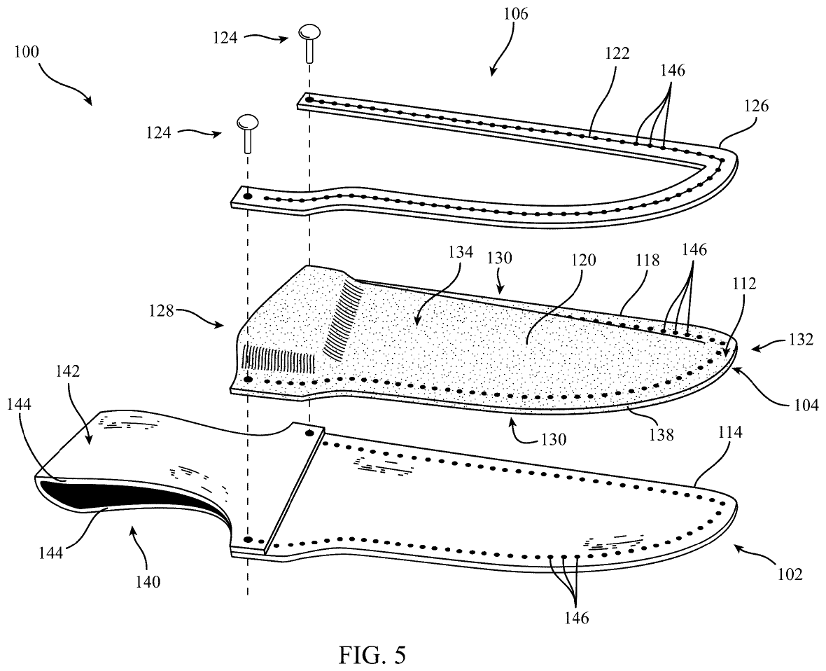

Referring to FIGS. 3A, 3B, and 5, the sheath 100 can optionally include a sheath connector 140 configured to connect the sheath to an article of clothing or other mount. For example, the sheath connector 140 can comprises a belt loop 142. In the illustrated embodiment, the backing 102 includes a portion folded over itself to form two layers 144 of the first material (e.g., leather) that form the belt loop 142. The folded over portion of the backing 102 can be secured with the stitching 122 and/or rivets 124. In this illustrated embodiment, both the stitching 122 and the rivets 124 are used. This results in a four layer construction at the rivets 124 (e.g., two layers from the backing 102, one layer from the shell 104, and one layer from the cover 106) and a three layer construction along the rest of the stitching (e.g., one layer each from the backing, shell, and cover). Other sheath connectors, such as clips, etc., can be used without departing from the scope of the present disclosure.

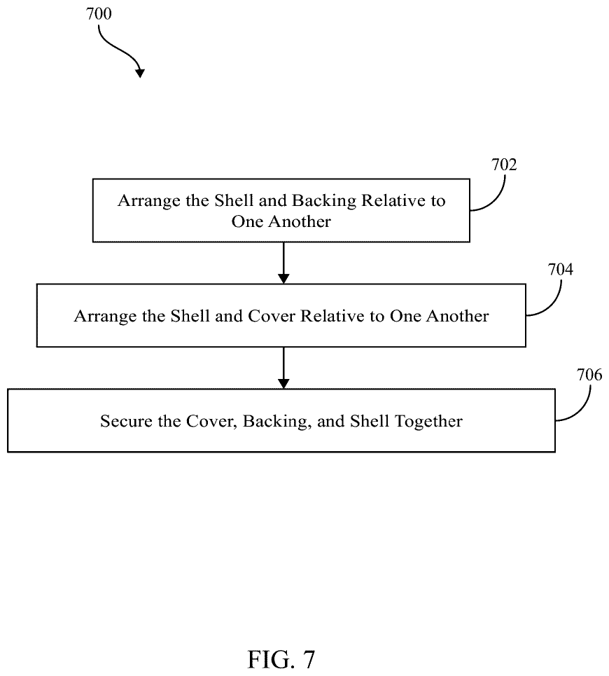

Referring to FIG. 7, a method of manufacturing the knife sheath 100 according to one embodiment of the present disclosure is generally indicated at reference number 700.

At step 702, the shell 104 is arranged relative to the backing 102 so that the shell and the backing bound the blade compartment 108 sized and shaped for receiving a knife blade. The backing 102 comprises a first material and the shell 104 comprises a second material different from the first material. Before step 702, the backing 102 is formed from a piece (e.g., panel, sheet, roll, etc.) of the first material (e.g., leather). For example, the backing 102 can be cut out from a piece the first material. If the knife sheath 100 includes the illustrated belt loop 142 as its sheath connector 140, the cutting may be performed in a manner to permit folding over of the backing 102 to form the belt loop. The backing 102 may be folded over to form the belt loop 142 prior to or during step 702. When the backing 102 is folded over, it forms two layers of the first material adjacent the upper end (e.g. compartment opening) of the knife receiver. The shell 104 is formed from a piece or portion of the second material (e.g., plastic). The shell 104 is formed to have a conforming fit with the knife 110, specifically the blade thereof and a portion of the handle. The shell 104 can be formed by heating a piece of the second material and molding the piece of second material with a mold, or can be injection molded. Other ways for forming the shell can be used without departing from the scope of the present disclosure. It is appreciated the manner of forming the shell will depend on the second material. For example, if the second material is metal, the shell 104 may be stamped from a piece of sheet metal.

After step 702, at step 704, the shell 104 and the cover 106 are arranged relative to one another so that the cover overlies the peripheral edge margin of the shell 112. For the illustrated knife sheath 100, where the cover 106 is a separate component from the backing 102, the cover is formed from a piece of the third material (e.g., leather). For example, the cover 106 can be cut out form a piece of the third material. The piece of the third material may be the same piece of the first material the backing 102 was cut from or a difference piece. In this embodiment, with the cover 106 formed, the cover and the backing 102 are located to sandwich the shell 104 (e.g., peripheral edge margin 112). This includes positing the cover 106 to overlie the edge margins of (desirably, in registration with the edges of) the shell 104 and the backing 102. In this embodiment, steps 702 and 704 may be performed sequentially or generally simultaneously. In the embodiment where the cover 106 is an integral part of the backing 102, step 704 includes folding a portion of the backing 102 around the peripheral edge margin 112 of the shell 104 to form the cover 106.

At step 706, the cover 106, backing 102, and shell 104 are coupled or secured together. This sandwiches the shell 105, specifically the peripheral edge margin 112 of the shell, between the cover 106 and the backing 102. For the illustrated knife sheath 100, step 706 includes stitching (with stitching 122) and riveting (with rivets 124) the cover 106, shell 104, and backing 102 together. Other suitable means to maintain the backing, shell, and cover in position with respect to one another can be used without departing from the scope of the present disclosure. The stitching and riveting includes forming (e.g., punching, drilling, etc.) a plurality of holes 146 throughout a peripheral edge margins of the cover 106, shell 104, and backing 102, for the stitching 122 and the rivets 124 to extend through. In one embodiment, the holes 146 are formed in each component (e.g., backing 102, shell 104, and cover 106) prior to arranging these components relative to one another (e.g., prior to steps 702 and 704). In one embodiment, the holes 146 in these components are formed together after the components are arranged relative to one another (e.g., after steps 702 and 704), such as by a press punching through these three components at the same time to form the holes. In the illustrated embodiment, securing the cover 106, the backing 102, and the shell 104 together also maintains the backing in the folded over arrangement to maintain the belt loop 141 (broadly, sheath connector 140). In the illustrated embodiment, the stitching and rivets are passed through the components to simultaneously couple the components. Non-simultaneous coupling methods (e.g., coupling the shell to the backing, then coupling the cover to the coupled shell/backing) can be used without departing from the scope of the present disclosure. Moreover, other ways of attaching the sheath connector can be used without departing from the scope of the present disclosure. Variations from the methods described herein, and other methods, can be used without departing from the scope of the present disclosure.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure are not limited in its application to the details of construction and the arrangement of components set forth in the following description or illustrated in the drawings. The aspects of the disclosure are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the disclosure defined in the appended claims. As various changes could be made in the above constructions and methods without departing from the scope of the disclosure, it is intended that all matter contained in the above description and shown in the accompanying drawings shall be interpreted as illustrative and not in a limiting sense.

In view of the above, it will be seen that several advantages of the aspects of the disclosure are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

When introducing elements of the disclosure or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

What is claimed is:

1. A knife sheath for a knife having a blade and a handle, the knife sheath comprising:
a backing comprising a first material;
a shell comprising a second material different than the first material, the shell supported by the backing, the shell and the backing bounding a blade compartment sized and shaped to receive the blade of the knife, the shell having a perimeter and including a peripheral edge margin forming a portion of the perimeter of the shell;
a cover comprising a third material different than the second material, the cover supported by the backing, the cover overlying the peripheral edge margin of the shell, the peripheral edge margin of the shell being disposed between the backing and the cover.

2. The knife sheath of claim 1, wherein the cover overlies the portion of the perimeter of the shell formed by the peripheral edge margin.

3. The knife sheath of claim 2, wherein the backing has a perimeter and the cover has a perimeter, wherein a portion of the perimeter of the backing, a portion of the perimeter of the cover, and the portion of the perimeter of the shell formed by the peripheral edge margin are all in registration with one another.

4. The knife sheath of claim 1, wherein the first material has a first flexibility and the second material has a second flexibility, the first flexibility being greater than the second flexibility.

5. The knife sheath of claim 1, wherein the first material is leather and the second material is polymeric.

6. The knife sheath of claim 1, wherein the cover and the backing sandwich the peripheral edge margin of the shell between the cover and the backing.

7. The knife sheath of claim 6, further comprising stitching extending through and connecting the cover, the peripheral edge margin of the shell, and the backing.

8. The knife sheath of claim 4, further comprising a rivet extending through and connecting the cover, the peripheral edge margin of the shell, and the backing.

9. The knife sheath of claim 1, wherein the third material is the same as the first material.

10. The knife sheath of claim 1, wherein the third material is different than the first material.

11. The knife sheath of claim 1, wherein the knife sheath comprises a front face and an opposite rear face, the backing forming the rear face, the shell and the cover forming the front face.

12. The knife sheath of claim 1, wherein the cover comprises a strip extending along the peripheral edge margin of the shell.

13. The knife sheath of claim 1, further comprising a sheath connector connected to the backing and configured to connect the knife sheath to an article of clothing.

14. A method of manufacturing a knife sheath for a knife having a blade and a handle, the method comprising:
arranging a shell and a backing relative to one another so that the shell and the backing bound a blade compartment sized and shaped for receiving the blade of the knife, the backing comprising a first material and the shell comprising a second material different than the first material;
arranging the shell and a cover relative to one another so that the cover overlies a peripheral edge margin of the shell, the cover comprising a third material different than the second material;
securing the cover, the backing, and the shell together such that the peripheral edge margin of the shell is sandwiched between the cover and the backing.

15. The method of claim 14, further comprising cutting the backing from a piece of the first material.

16. The method of claim 14, further comprising forming the shell by molding.

17. The method of claim 14, wherein said securing includes stitching the cover the shell, and the backing together.

18. The method of claim 14, wherein said securing includes fastening the cover, the shell, and the backing together with a fastener.

19. The method of claim 14, wherein said arranging the shell and the cover relative to one another includes folding a portion of the backing around the peripheral edge margin of the shell to form the cover.

20. The method of claim 14, further comprising forming a belt loop with the backing.
